(19) United States
(12) Patent Application Publication
(10) Pub. No.: US 2018/0269714 A1
(43) Pub. Date: Sep. 20, 2018

(54) DOUBLE-D SPLIT COIL WINDING

(71) Applicant: QUALCOMM Incorporated, San Diego, CA (US)

(72) Inventors: Johan Gabriel SAMUELSSON, Aying (DE); Nicholas Athol KEELING, Munich (DE); Maciej SKOWRON, Munich (DE)

(21) Appl. No.: 15/460,337

(22) Filed: Mar. 16, 2017

(51) Int. Cl. H02J 50/10; H01F 27/28; H01F 27/24; H02J 50/90; H01F 41/02; H01F 41/06; B60L 11/18

(52) U.S. Cl. CPC H02J 50/10; H01F 27/28; H01F 27/24; B60L 11/182; H01F 41/02; H01F 41/06; H02J 50/90

(57) ABSTRACT

Techniques for manufacturing an induction coil for use in a wireless power transfer system are provided. An example of a wireless power transfer device according to the disclosure includes a first combined ferrite and coil holder and a second combined ferrite and coil holder, such that the first combined ferrite and coil holder and the second combined ferrite and coil holder are separate components, a first coil disposed on the first combined ferrite and coil holder, and a second coil disposed on the second combined ferrite and coil holder, such that the second combined ferrite and coil holder is adjacent to and coplanar with the first combined ferrite and coil holder, and the first coil and the second coil are operably coupled to one another.

### FIELD

This application is generally related to wireless charging power transfer applications, and specifically to a method and apparatus for winding an induction coil for use in a wireless power transfer system.

### BACKGROUND

Chargeable systems, such as vehicles, have been introduced that include locomotion power derived from electricity received from an energy storage device such as a battery. Vehicles that are solely electric generally receive the electricity for charging the batteries from other sources. Battery electric vehicles are often proposed to be charged through some type of wireless charging system that is capable of transferring power in free space (e.g., via a wireless field). A charging system may utilize one or more wire coils to generate and receive the wireless field. For example, a base pad may include a wire coil to generate the wireless field and a vehicle pad may include a wire coil to receive the wireless field. There is an increasing demand for wireless charging systems and thus a need to improve the manufacturability of the base pad and vehicle pad coils.

### SUMMARY

An example of a wireless power transfer device according to the disclosure includes a first combined ferrite and coil holder and a second combined ferrite and coil holder, such that the first combined ferrite and coil holder and the second combined ferrite and coil holder are separate components, a first coil disposed on the first combined ferrite and coil holder, and a second coil disposed on the second combined ferrite and coil holder, such that the second combined ferrite and coil holder is adjacent to and coplanar with the first combined ferrite and coil holder, and the first coil and the second coil are operably coupled to one another.

Implementations of such a wireless power transfer device may include one or more of the following features. A first ferrite block structure may be disposed on a first side of the first combined ferrite and coil holder, a second ferrite block structure may be disposed on the first side of the first combined ferrite and coil holder, a third ferrite block structure may be disposed on a first side of the second combined ferrite and coil holder, a fourth ferrite block structure may be disposed on the first side of the second combined ferrite and coil holder, a fifth ferrite block structure may be disposed across at least a portion of a second side opposite the first side of the first combined ferrite and coil holder and a second side of the second combined ferrite and coil holder, and a sixth ferrite block structure may be disposed across at least a portion of the second side of the first combined ferrite and coil holder and the second side of the second combined ferrite and coil holder. The first side of the first combined ferrite and coil holder may include a plurality of recesses configured to accommodate the first ferrite block structure and the second ferrite block structure. The second side of the first combined ferrite and coil holder may include a plurality of recesses configured to accommodate at least a portion of the fifth ferrite block structure and at least a portion of the sixth ferrite block structure. The first combined ferrite and coil holder and the second combined ferrite and coil holder may be disposed within a first cover assembly and a second cover assembly. The first coil and the second coil are comprised of uni-filar litz wire. The first combined ferrite and coil holder and the second combined ferrite and coil holder may have the same form factor. The first combined ferrite and coil holder may include a plurality of ribs configured to align the first coil. The first combined ferrite and coil holder may include one or more alignment structures. The first coil and the second coil may be operably connected to generate a horizontal flux across the wireless power transfer device. The first coil may be wound around the first combined ferrite and coil holder in a first direction, the second coil may be wound around the second combined ferrite and coil holder in a second direction, and the first coil and the second coil may be operably coupled in an electrically parallel configuration. The first coil may be wound around the first combined ferrite and coil holder in a first direction, the second coil may be wound around the second combined ferrite and coil holder in the first direction, and the first coil and the second coil may be operably coupled in an electrically serial configuration. The first combined ferrite and coil holder may include a first coil outside lead access port, the second combined ferrite and coil holder may include a second coil outside lead access port, such that the first coil outside lead access port and the second coil outside lead access port are adjacent when the second combined ferrite and coil holder is adjacent to and coplanar with the first combined ferrite and coil holder.

An example method of assembling an induction coil according to the disclosure includes winding a first coil about a first combined ferrite and coil holder in a first direction, such that the first coil includes an inside lead and an outside lead, winding a second coil about a second combined ferrite and coil holder in a second direction, such that the second coil includes an inside lead and an outside lead and the second direction is opposite of the first direction, disposing the first combined ferrite and coil holder and the second combined ferrite and coil holder in an adjacent configuration, wherein the first coil and the second coil are coplanar, and operably coupling the first coil and the second coil in a parallel configuration, wherein the inside lead on the first coil is connected to the inside lead on the second coil and the outside lead on the first coil is connected to the outside lead on the second coil.

Implementations of such a method may include one or more of the following features. The first combined ferrite and coil holder and the second combined ferrite and coil holder may have the same form factor. The method may include positioning a first ferrite block structure on a first side of the first combined ferrite and coil holder, positioning a second ferrite block structure to the first side of the first combined ferrite and coil holder, positioning a third ferrite block structure to a first side of the second combined ferrite and coil holder, positioning a fourth ferrite block structure to the first side of the second combined ferrite and coil holder, positioning a fifth ferrite block structure to a second side opposite the first side of the first combined ferrite and coil holder and a second side opposite the first side of the second combined ferrite and coil holder, and positioning a sixth ferrite block structure to the second side of the first combined ferrite and coil holder and the bottom of the second combined ferrite and coil holder. The first combined ferrite and coil and the second combined ferrite and coil may be encased within a top cover assembly and a bottom cover assembly. The inside lead and the outside lead of the first coil and the second coil to may be coupled to a power converter. The induction coil may be disposed on a vehicle such that the first side of the first combined ferrite and coil holder and the second combined ferrite and coil holder are directed to a base system induction coil.

An example of an apparatus according to the disclosure includes a first holder means for securing a first coil, such that the first coil includes an inside lead and an outside lead, a second holder means for securing a second coil, such that the second coil includes an inside lead and an outside lead, an assembly cover means for disposing the first holder means and the second holder means in an adjacent configuration, such that the first coil and the second coil are coplanar, and a coupling means for electrically coupling the first coil and the second coil.

Implementations of such an apparatus may include one or more of the following features. The coupling means may include electrically coupling the first coil and the second coil in a parallel configuration, such that the inside lead on the first coil is connected to the inside lead on the second coil and the outside lead on the first coil is connected to the outside lead on the second coil. The coupling means may include electrically coupling the first coil and the second coil in a serial configuration, such that the inside lead on the first coil is connected to the outside lead on the second coil and the outside lead on the first coil is connected to the inside lead on the second coil. The first holder means and the second holder means may have the same form factor. The apparatus may included means for positioning a first ferrite block structure on a first side of the first holder means, means for positioning a second ferrite block structure to the first side of the first holder means, means for positioning a third ferrite block structure to a first side of the second holder means, means for positioning a fourth ferrite block structure to the first side of the second holder means, means for positioning a fifth ferrite block structure to a second side opposite the first side of the first holder means and a second side opposite the first side of the second holder means, and means for positioning a sixth ferrite block structure to the second side of the first holder means and the second side of the second holder means. A means for coupling the first coil and the second coil to a power converter means. The apparatus may be disposed on a vehicle such that a first side of the first holder means and the second holder means are directed to a base system induction coil.

An example of a wireless power transfer device according to the disclosure includes a first coil holder and a second coil holder, such that the first coil holder and the second coil holder have the same form factor, a first coil disposed on the first coil holder, a second coil disposed on the second coil holder, such that the second coil holder is adjacent to and coplanar with the first coil holder, and the first coil and the second coil are operably coupled to one another, a first ferrite block structure disposed on a first side of the first coil holder, a second ferrite block structure disposed on the first side of the first coil holder, a third ferrite block structure disposed on a first side of the second coil holder, a fourth ferrite block structure disposed on the first side of the second coil holder, a fifth ferrite block structure disposed across at least a portion of a second side opposite the first side of the first coil holder and a second side of the second coil holder, and a sixth ferrite block structure disposed across at least a portion of the second side of the first coil holder and the second side of the second coil holder.

Implementations of such a wireless power transfer device may include one or more of the following features. The first side of the first coil holder may include a plurality of recesses configured to accommodate the first ferrite block structure and the second ferrite block structure. The first coil may be wound around the first coil holder in a first direction, the second coil may be wound around the second coil holder in a second direction, and the first coil and the second coil may be operably coupled in an electrically parallel configuration. The first coil may be wound around the first coil holder in a first direction, the second coil may be wound around the second coil holder in the first direction, and the first coil and the second coil may be operably coupled in an electrically serial configuration.

Items and/or techniques described herein may provide one or more of the following capabilities, as well as other capabilities not mentioned. A double-D coil holder may be split into two separate coil holders. The separate coil holders may have identical form factors. Each of the separate coil holders may be wound with a single wire. The single wire may be litz wire. The wire may be secured in place at each turn by ribs located within the coil holder. The windings on both coil holders may be symmetric. A wire winding machine may be used to wind the single wire on the holder. High volume and repeatable automated manufacturing may be realized. The coil holders may include recesses to accommodate ferrite blocks. Ferrite blocks may be affixed to the holders before the single wire is wound around the holder. The wound holders may be disposed adjacent to one another such that the coils are in a coplanar orientation. The coils may be operably coupled in an electrically parallel or serial configuration. A double-D structure may be achieved. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 illustrates a wireless power transfer system for charging an electric vehicle, in accordance with some implementations.

FIG. 2 is a schematic diagram of exemplary components of the wireless power transfer system of FIG. 1.

FIG. 3 is a functional block diagram showing exemplary components of the wireless power transfer system of FIG. 1.

FIGS. 4A-4C are prior art examples of winding bifilar wire on a coil holder.

FIG. 5 is an example of a parallel coil winding structure for a double-d (DD) configuration.

FIG. 6A is a top view perspective illustration of two adjacent combined ferrite and coil holders with parallel windings.

FIG. 6B is a bottom view perspective illustration of the two adjacent combined ferrite and coil holders with parallel windings in FIG. 6A.

FIG. 7A is a top view perspective illustration of a first combined ferrite and coil holder.

FIG. 7B is a top view perspective illustration of a second combined ferrite and coil holder.

FIG. 7C is a top view perspective illustration of the first and second combined ferrite and coil holders in an adjacent configuration.

FIG. 8A is a top view perspective illustration of the first combined ferrite and coil holder with a first coil wound in a first direction.

FIG. 8B is a top view perspective illustration of the second combined ferrite and coil holder with a second coil wound in a second direction.

FIG. 9 is an exploded diagram of an example of an induction coil.

FIG. 10 is a process flow diagram for a method of assembling a double-D coil for an induction coil.

FIG. 11 is a process flow diagram for another method of assembling a double-D coil for an induction coil.

### DETAILED DESCRIPTION

Techniques are discussed herein for winding induction coils in a wireless power transfer system, and in particular for efficiently winding an inductive coil in a double-D configuration.

Efficiency in wireless inductive charging power applications depends at least in part on the orientation and the respective configurations of a wireless power transmitter and a wireless power receiver. The configuration and orientation of electrical conductors (i.e., coils) within each of the wireless power transmitter and receiver may vary based on the expected level of power transfer, installation limitations, and other design consideration. In a Wireless Electric Vehicle Charging (WEVC) charging systems, the coils (e.g., electrical conductors) within the transmitter and receiver include bifilar litz wire. As used herein, bifilar litz wire is a bifilar coil including two closely spaced parallel windings of litz wire. The use of litz wire is exemplary only in view of current industry practices. Other types of wire may also be used. In WEVC applications, some transmitter or receiver coil designs may provide operational benefits but significant manufacturing issues may prohibit large scale implementation of the designs. For example, winding a bifilar litz wire in some transmitter and receiver coil designs can be time consuming because the litz wire may not conform consistently to every turn in a coil holder. Further, since some transmitter and receiver coil designs must be wound by hand, it is difficult to replicate the process accurately. Additionally, some transmitter and receiver coil designs are not symmetric, which can create a difference in inductances and may degrade the operational performance of the transmitter or receiver. In general, winding bifilar coils is a complex process which may increase the manufacturing costs for some wireless inductive charging power applications.

The detailed description set forth below in connection with the appended drawings is intended as a description of exemplary implementations and is not intended to represent the only implementations in which the invention may be practiced. The term “exemplary” used throughout this description means “serving as an example, instance, or illustration,” and should not necessarily be construed as preferred or advantageous over other exemplary implementations. The detailed description includes specific details for the purpose of providing a thorough understanding of the exemplary implementations. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer.

An electric vehicle is used herein to describe a remote system, an example of which is a vehicle that includes, as part of its locomotion capabilities, electrical power derived from a chargeable energy storage device (e.g., one or more rechargeable electrochemical cells or other type of battery). As non-limiting examples, some electric vehicles may be hybrid electric vehicles that include, besides electric motors, a traditional combustion engine for direct locomotion or to charge the vehicle's battery. Other electric vehicles may draw all locomotion ability from electrical power. An electric vehicle is not limited to an automobile and may include motorcycles, carts, scooters, and the like. By way of example and not limitation, a remote system is described herein in the form of an electric vehicle (EV). Furthermore, other remote systems that may be at least partially powered using a chargeable energy storage device are also contemplated (e.g., electronic devices such as personal computing devices and the like).

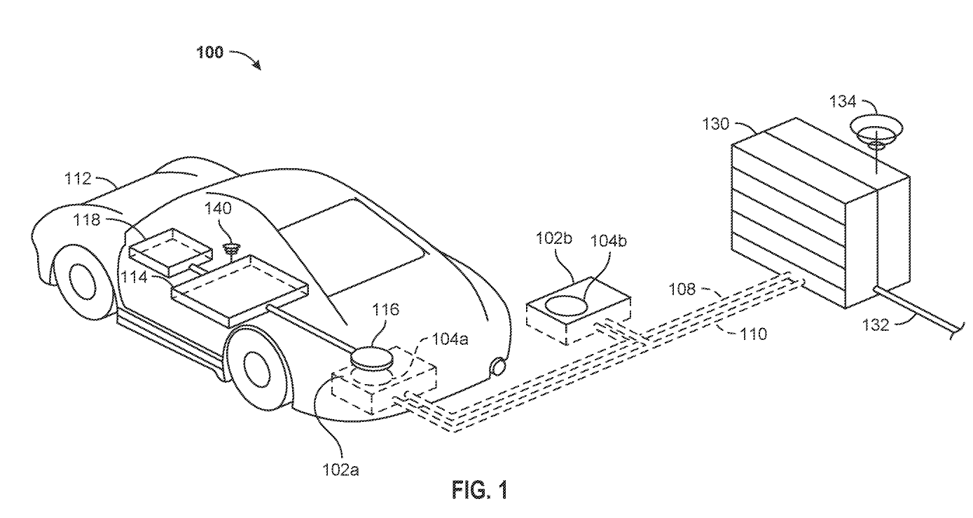

Referring to FIG. 1, a diagram of an exemplary wireless power transfer system 100 for charging an electric vehicle is shown. The wireless power transfer system 100 enables charging of an electric vehicle 112 while the electric vehicle 112 is parked so as to efficiently couple with a base wireless charging system 102a. Spaces for two electric vehicles are illustrated in a parking area to be parked over corresponding base wireless charging systems 102a and 102b. In some implementations, a local distribution center 130 may be connected to a power backbone 132 and configured to provide an alternating current (AC) or a direct current (DC) supply through a power link 110 to the base wireless charging systems 102a and 102b. Each of the base wireless charging systems 102a and 102b also includes a base system induction coil 104a and 104b, respectively, for wirelessly transferring power. In some other implementations (not shown in FIG. 1), base system induction coils 104a or 104b may be stand-alone physical units and are not part of the base wireless charging system 102a or 102b.

The electric vehicle 112 may include a battery unit 118, an electric vehicle induction coil 116, and an electric vehicle wireless charging unit 114. The electric vehicle wireless charging unit 114 and the electric vehicle induction coil 116 constitute the electric vehicle wireless charging system. In some diagrams shown herein, the electric vehicle wireless charging unit 114 is also referred to as the vehicle charging unit (VCU). The electric vehicle induction coil 116 may interact with the base system induction coil 104a for example, via a region of the electromagnetic field generated by the base system induction coil 104a.

In some exemplary implementations, the electric vehicle induction coil 116 may receive power when the electric vehicle induction coil 116 is located in an electromagnetic field produced by the base system induction coil 104a. The field may correspond to a region where energy output by the base system induction coil 104a may be captured by the electric vehicle induction coil 116. For example, the energy output by the base system induction coil 104a may be at a level sufficient to charge or power the electric vehicle 112. In some cases, the field may correspond to a “near-field” of the base system induction coil 104a. The near-field may correspond to a region in which there are strong reactive fields resulting from the currents and charges in the base system induction coil 104a that do not radiate power away from the base system induction coil 104a. In some cases the near-field may correspond to a region that is within about 1/2n of a wavelength of the a frequency of the electromagnetic field produced by the base system induction coil 104a distant from the base system induction coil 104a, as will be further described below.

Local distribution center 130 may be configured to communicate with external sources (e.g., a power grid) via a communication backhaul 134, and with the base wireless charging system 102a via a communication link 108.

In some implementations the electric vehicle induction coil 116 may be aligned with the base system induction coil 104a and, therefore, disposed within a near-field region simply by the electric vehicle operator positioning the electric vehicle 112 such that the electric vehicle induction coil 116 is sufficiently aligned relative to the base system induction coil 104a. Alignment may be considered sufficient when an alignment error has fallen below a tolerable value. In other implementations, the operator may be given visual and/or auditory feedback to determine when the electric vehicle 112 is properly placed within a tolerance area for wireless power transfer. In yet other implementations, the electric vehicle 112 may be positioned by an autopilot system, which may move the electric vehicle 112 until the sufficient alignment is achieved. This may be performed automatically and autonomously by the electric vehicle 112 with or without driver intervention. This may be possible for an electric vehicle 112 that is equipped with a servo steering, radar sensors (e.g., ultrasonic sensors), and intelligence for safely maneuvering and adjusting the electric vehicle. In still other implementations, the electric vehicle 112 and/or the base wireless charging system 102a may have functionality for mechanically displacing and moving the coils 116 and 104a, respectively, relative to each other to more accurately orient or align them and develop sufficient and/or otherwise more efficient coupling there between.

The base wireless charging system 102a may be located in a variety of locations. As non-limiting examples, some suitable locations include a parking area at a home of the electric vehicle 112 owner, parking areas reserved for electric vehicle wireless charging modeled after conventional petroleum-based filling stations, and parking lots at other locations such as shopping centers and places of employment.

Charging electric vehicles wirelessly may provide numerous benefits. For example, charging may be performed automatically, virtually without driver intervention or manipulation thereby improving convenience to a user. There may also be no exposed electrical contacts and no mechanical wear out, thereby improving reliability of the wireless power transfer system 100. Safety may be improved since manipulations with cables and connectors may not be needed and there may be no cables, plugs, or sockets to be exposed to moisture in an outdoor environment. In addition, there may also be no visible or accessible sockets, cables, or plugs, thereby reducing potential vandalism of power charging devices. Further, since the electric vehicle 112 may be used as distributed storage devices to stabilize a power grid, a convenient docking-to-grid solution may help to increase availability of vehicles for vehicle-to-grid (V2G) operation.

The wireless power transfer system 100 as described with reference to FIG. 1 may also provide aesthetical and non-impedimental advantages. For example, there may be no charge columns and cables that may be impedimental for vehicles and/or pedestrians.

As a further explanation of the vehicle-to-grid capability, the wireless power transmit and receive capabilities may be configured to be reciprocal such that either the base wireless charging system 102a can transmit power to the electric vehicle 112 or the electric vehicle 112 can transmit power to the base wireless charging system 102a. This capability may be useful to stabilize the power distribution grid by allowing electric vehicles 112 to contribute power to the overall distribution system in times of energy shortfall caused by over demand or shortfall in renewable energy production (e.g., wind or solar).

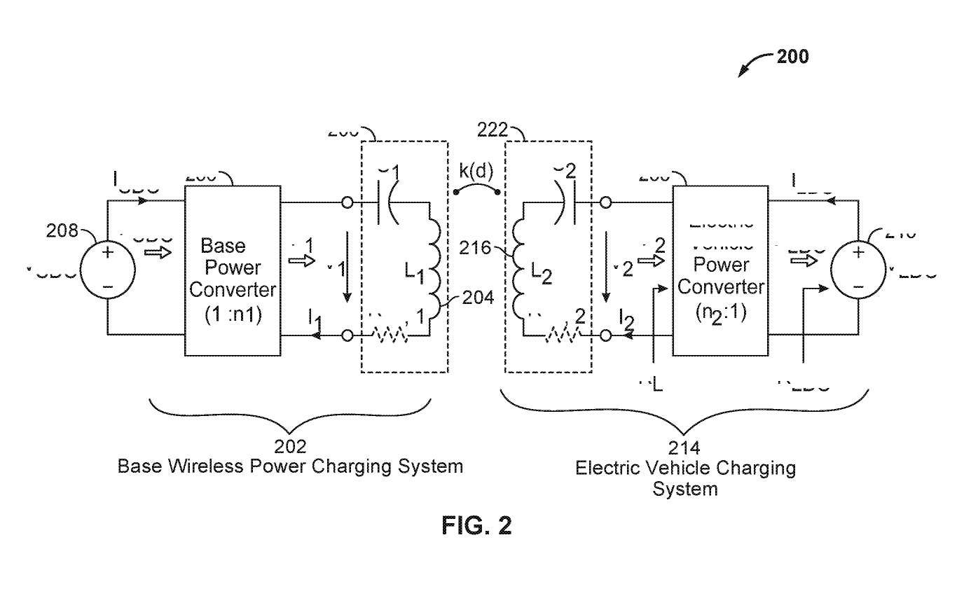

FIG. 2 is a schematic diagram of exemplary components of a wireless power transfer system 200 similar to that previously discussed in connection with FIG. 1, in accordance with some exemplary implementations. The wireless power transfer system 200 may include a base resonant circuit 206 including a base system induction coil 204 having an inductance L1. The wireless power transfer system 200 further includes an electric vehicle resonant circuit 222 including an electric vehicle induction coil 216 having an inductance L2. Implementations described herein may use capacitively loaded conductor loops (i.e., multi-turn coils) forming a resonant structure that is capable of efficiently coupling energy from a primary structure (transmitter) to a secondary structure (receiver) via a magnetic or electromagnetic near-field if both the transmitter and the receiver are tuned to a common resonant frequency. The coils may be used for the electric vehicle induction coil 216 and the base system induction coil 204. Using resonant structures for coupling energy may be referred to as “magnetically coupled resonance,” “electromagnetically coupled resonance,” and/or “resonant induction.” The operation of the wireless power transfer system 200 will be described based on power transfer from a base system induction coil 204 to an electric vehicle 112 (not shown), but is not limited thereto. For example, as discussed above, energy may be also transferred in the reverse direction.

Referring to FIG. 2, a power supply 208 (e.g., AC or DC) supplies power PSDC to the base power converter 236 as part of the base wireless power charging system 202 to transfer energy to an electric vehicle (e.g., electric vehicle 112 of FIG. 1). The base power converter 236 may include circuitry such as an AC-to-DC converter configured to convert power from standard mains AC to DC power at a suitable voltage level, and a DC-to-low frequency (LF) converter configured to convert DC power to power at an operating frequency suitable for wireless high power transfer. The base power converter 236 supplies power P1 to the base resonant circuit 206 including tuning capacitor C1 in series with base system induction coil 204 to emit an electromagnetic field at the operating frequency. The series-tuned resonant circuit 206 should be construed as exemplary. In another implementation, the capacitor C1 may be coupled with the base system induction coil 204 in parallel. In yet other implementations, tuning may be formed of several reactive elements in any combination of parallel or series topology. The capacitor Cl may be provided to form a resonant circuit with the base system induction coil 204 that resonates substantially at the operating frequency. The base system induction coil 204 receives the power P1 and wirelessly transmits power at a level sufficient to charge or power the electric vehicle. For example, the level of power provided wirelessly by the base system induction coil 204 may be on the order of kilowatts (kW) (e.g., anywhere from 1 kW to 110 kW, although actual levels may be or higher or lower).

The base resonant circuit 206 (including the base system induction coil 204 and tuning capacitor C1) and the electric vehicle resonant circuit 222 (including the electric vehicle induction coil 216 and tuning capacitor C2) may be tuned to substantially the same frequency. The electric vehicle induction coil 216 may be positioned within the near-field of the base system induction coil and vice versa, as further explained below. In this case, the base system induction coil 204 and the electric vehicle induction coil 216 may become coupled to one another such that power may be transferred wirelessly from the base system induction coil 204 to the electric vehicle induction coil 216. The series capacitor C2 may be provided to form a resonant circuit with the electric vehicle induction coil 216 that resonates substantially at the operating frequency. The series-tuned resonant circuit 222 should be construed as being exemplary. In another implementation, the capacitor C2 may be coupled with the electric vehicle induction coil 216 in parallel. In yet other implementations, the electric vehicle resonant circuit 222 may be formed of several reactive elements in any combination of parallel or series topology. Element k(d) represents the mutual coupling coefficient resulting at coil separation d. Equivalent resistances Req,1 and Req,2 represent the losses that may be inherent to the base and electric vehicle induction coils 204 and 216 and the tuning (anti-reactance) capacitors C1 and C2, respectively. The electric vehicle resonant circuit 222, including the electric vehicle induction coil 216 and capacitor C2, receives and provides the power P2 to an electric vehicle power converter 238 of an electric vehicle charging system 214. The electric vehicle power converter 238 may be a power converter means.

The electric vehicle power converter 238 may include, among other things, a LF-to-DC converter configured to convert power at an operating frequency back to DC power at a voltage level of the load 218 that may represent the electric vehicle battery unit. The electric vehicle power converter 238 may provide the converted power PLDC to the load 218. The power supply 208, base power converter 236, and base system induction coil 204 may be stationary and located at a variety of locations as discussed above. The electric vehicle load 218 (e.g., the electric vehicle battery unit), electric vehicle power converter 238, and electric vehicle induction coil 216 may be included in the electric vehicle charging system 214 that is part of the electric vehicle (e.g., electric vehicle 112) or part of its battery pack (not shown). The electric vehicle charging system 214 may also be configured to provide power wirelessly through the electric vehicle induction coil 216 to the base wireless power charging system 202 to feed power back to the grid. Each of the electric vehicle induction coil 216 and the base system induction coil 204 may act as transmit or receive coils based on the mode of operation.

While not shown, the wireless power transfer system 200 may include a load disconnect unit (LDU) (not known) to safely disconnect the electric vehicle load 218 or the power supply 208 from the wireless power transfer system 200. For example, in case of an emergency or system failure, the LDU may be triggered to disconnect the load from the wireless power transfer system 200. The LDU may be provided in addition to a battery management system for managing charging to a battery, or it may be part of the battery management system.

Further, the electric vehicle charging system 214 may include switching circuitry (not shown) for selectively connecting and disconnecting the electric vehicle induction coil 216 to the electric vehicle power converter 238. Disconnecting the electric vehicle induction coil 216 may suspend charging and also may change the “load” as “seen” by the base wireless power charging system 202 (acting as a transmitter), which may be used to “cloak” the electric vehicle charging system 214 (acting as the receiver) from the base wireless charging system 202. The load changes may be detected if the transmitter includes a load sensing circuit. Accordingly, the transmitter, such as the base wireless charging system 202, may have a mechanism for determining when receivers, such as the electric vehicle charging system 214, are present in the near-field coupling mode region of the base system induction coil 204 as further explained below.

As described above, in operation, during energy transfer towards an electric vehicle (e.g., electric vehicle 112 of FIG. 1), input power is provided from the power supply 208 such that the base system induction coil 204 generates an electromagnetic field for providing the energy transfer. The electric vehicle induction coil 216 couples to the electromagnetic field and generates output power for storage or consumption by the electric vehicle 112. As described above, in some implementations, the base resonant circuit 206 and electric vehicle resonant circuit 222 are configured and tuned according to a mutual resonant relationship such that they are resonating nearly or substantially at the operating frequency. Transmission losses between the base wireless power charging system 202 and electric vehicle charging system 214 are minimal when the electric vehicle induction coil 216 is located in the near-field coupling mode region of the base system induction coil 204 as further explained below.

As stated, an efficient energy transfer occurs by transferring energy via a magnetic near-field rather than via electromagnetic waves in the far field, which may involve substantial losses due to radiation into the space. When in the near-field, a coupling mode may be established between the transmit coil and the receive coil. The space around the coils where this near-field coupling may occur is referred to herein as a near-field coupling mode region.

While not shown, the base power converter 236 and the electric vehicle power converter 238 if bidirectional may both include, for the transmit mode, an oscillator, a driver circuit such as a power amplifier, a filter and matching circuit, and for the receive mode a rectifier circuit. The oscillator may be configured to generate a desired operating frequency, which may be adjusted in response to an adjustment signal. The oscillator signal may be amplified by a power amplifier with an amplification amount responsive to control signals. The filter and matching circuit may be included to filter out harmonics or other unwanted frequencies and match the impedance as presented by the resonant circuits 206 and 222 to the base and electric vehicle power converters 236 and 238, respectively. For the receive mode, the base and electric vehicle power converters 236 and 238 may also include a rectifier and switching circuitry.

The electric vehicle induction coil 216 and base system induction coil 204 as described throughout the disclosed embodiments may be referred to or configured as “loop” antennas, and more specifically, multi-turn loop antennas. The induction coils 204 and 216 may also be referred to herein or be configured as “magnetic” antennas. The term “coil” generally refers to a component that may wirelessly output or receive energy four coupling to another “coil.” The coil may also be referred to as an “antenna” of a type that is configured to wirelessly output or receive power. As used herein, coils 204 and 216 are examples of “power transfer components” of a type that are configured to wirelessly output, wirelessly receive, and/or wirelessly relay power. Loop (e.g., multi-turn loop) antennas may be configured to include an air core or a physical core such as a ferrite core. An air core loop antenna may allow the placement of other components within the core area. Physical core antennas including ferromagnetic or ferromagnetic materials may allow development of a stronger electromagnetic field and improved coupling. The coils may be litz wire.

As discussed above, efficient transfer of energy between a transmitter and receiver occurs during matched or nearly matched resonance between a transmitter and a receiver. However, even when resonance between a transmitter and receiver are not matched, energy may be transferred at a lower efficiency. Transfer of energy occurs by coupling energy from the near field of the transmitting induction coil to the receiving induction coil residing within a region (e.g., within a predetermined frequency range of the resonant frequency, or within a predetermined distance of the near-field region) where this near field is established rather than propagating the energy from the transmitting induction coil into free space.

A resonant frequency may be based on the inductance and capacitance of a resonant circuit (e.g. resonant circuit 206) including a coil (e.g., the base system induction coil 204 and capacitor C2) as described above. As shown in FIG. 2, inductance may generally be the inductance of the coil, whereas, capacitance may be added to the coil to create a resonant structure at a desired resonant frequency. Accordingly, for larger size coils (i.e., using larger diameter coils exhibiting larger inductance), the value of capacitance needed to produce resonance may be lower. Inductance may also depend on a number of turns of a coil. Furthermore, as the size of the coils increases, coupling efficiency may increase. This is mainly true if the size of both base and electric vehicle induction coils increase. Furthermore a resonant circuit including a coil and tuning capacitor may be designed to have a high quality (Q) factor to improve energy transfer efficiency.

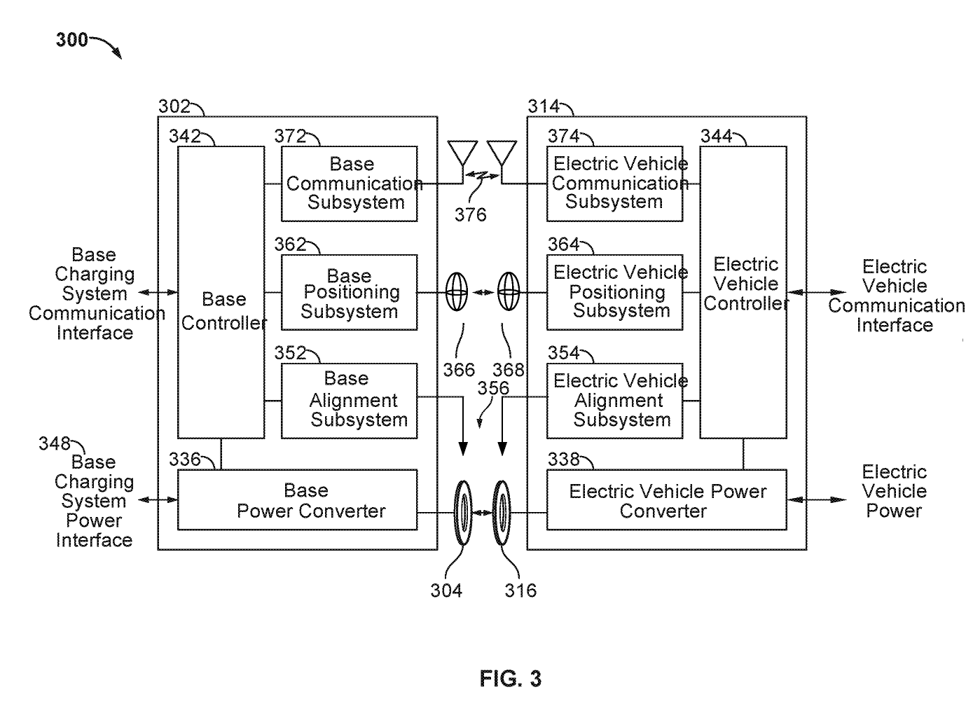

Referring to FIG. 3, a functional block diagram of exemplary components of wireless power transfer system 300 is shown. The wireless power transfer system 300 may be employed in wireless power transfer system 100 of FIG. 1 and/or that wireless power transfer system 200 of FIG. 2. The wireless power transfer system 300 illustrates a communication link 376, a positioning link 366, using, for example, a magnetic field signal for determining a position or direction, and an alignment mechanism 356 capable of mechanically moving one or both of the base system induction coil 304 and the electric vehicle induction coil 316. Mechanical (kinematic) alignment of the base system induction coil 304 and the electric vehicle induction coil 316 may be controlled by the base alignment subsystem 352 and the electric vehicle charging alignment subsystem 354, respectively. The positioning link 366 may be capable of bi-directional signaling, meaning that positioning signals may be emitted by the base positioning subsystem or the electric vehicle positioning subsystem or by both. As described above with reference to FIG. 1, when energy flows towards the electric vehicle 112, in FIG. 3 a base charging system power interface 348 may be configured to provide power to a base power converter 336 from a power source, such as an AC or DC power supply (not shown). The base power converter 336 may receive AC or DC power via the base charging system power interface 348 to drive the base system induction coil 304 at a frequency near or at the resonant frequency of the base resonant circuit 206 with reference to FIG. 2. The electric vehicle induction coil 316, when in the near-field coupling-mode region, may receive energy from the electromagnetic field to oscillate at or near the resonant frequency of the electric vehicle resonant circuit 222 with reference to FIG. 2. The electric vehicle power converter 338 converts the oscillating signal from the electric vehicle induction coil 316 to a power signal suitable for charging a battery via the electric vehicle power interface.

The base wireless charging system 302 includes a base controller 342 and the electric vehicle wireless charging system 314 includes an electric vehicle controller 344. The base controller 342 may provide a base charging system communication interface to other systems (not shown) such as, for example, a computer, a base common communication (BCC), a communications entity of the power distribution center, or a communications entity of a smart power grid. The electric vehicle controller 344 may provide an electric vehicle communication interface to other systems (not shown) such as, for example, an on-board computer on the vehicle, a battery management system, other systems within the vehicles, and remote systems.

The base communication subsystem 372 and electric vehicle communication subsystem 374 may include subsystems or modules for specific application with separate communication channels and also for wirelessly communicating with other communications entities not shown in the diagram of FIG. 3. These communications channels may be separate physical channels or separate logical channels. As non-limiting examples, a base alignment subsystem 352 may communicate with an electric vehicle alignment subsystem 354 through communication link 376 to provide a feedback mechanism for more closely aligning the base system induction coil 304 and the electric vehicle induction coil 316, for example via autonomous mechanical (kinematic) alignment, by either the electric vehicle alignment subsystem 354 or the base alignment subsystem 352, or by both, or with operator assistance as described herein.

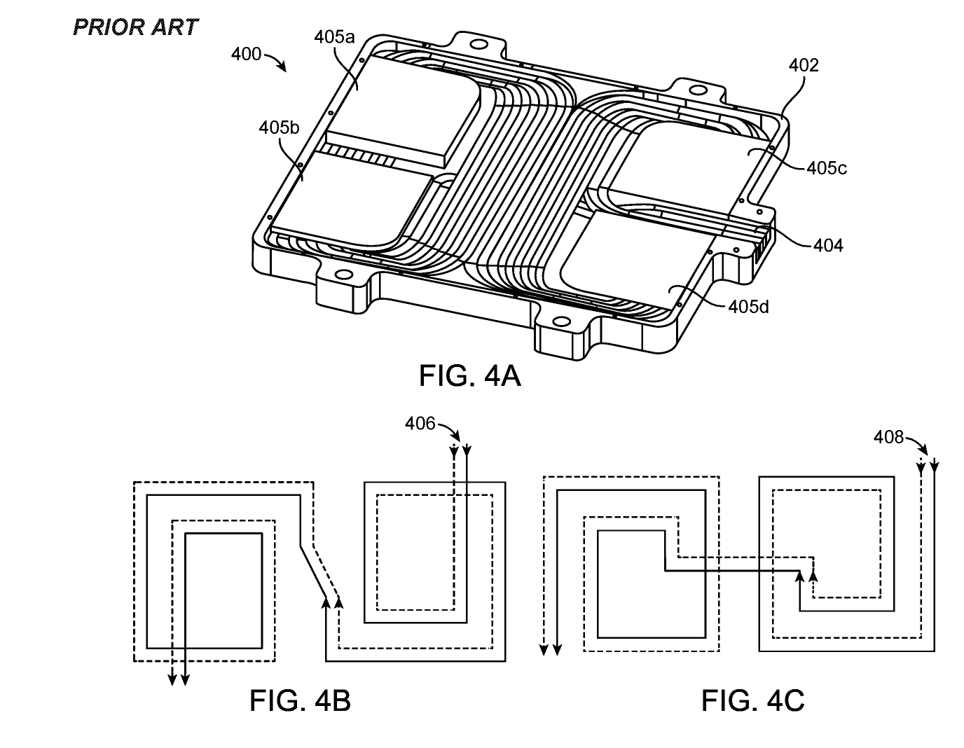

The electric vehicle wireless charging system 314 may further include an electric vehicle positioning subsystem 364 connected to a magnetic field generator 368. The electric vehicle positioning subsystem 364 may be configured to drive the magnetic field generator 368 with currents that generate an alternating magnetic field. The base wireless charging system 302 may include a magnetic field sensor 366 connected to a base positioning subsystem 362. The magnetic field sensor 366 may be configured to generate a plurality of voltage signals under influence of the alternating magnetic field generated by the magnetic field generator 368. The base positioning subsystem 362 may be configured to receive these voltage signals and output a signal indicative of a position estimate and an angle estimate between the magnetic field sensor 366 and the magnetic field sensor 368, as will be described in more detail in connection with FIGS. 4-30. These position and angle estimates may be translated into visual and/or acoustic guidance and alignment information that a driver of the electric vehicle may use to reliably park the vehicle. In some implementations, these position and angle estimates may be used to park a vehicle automatically with no or only minimal driver intervention (drive by wire).

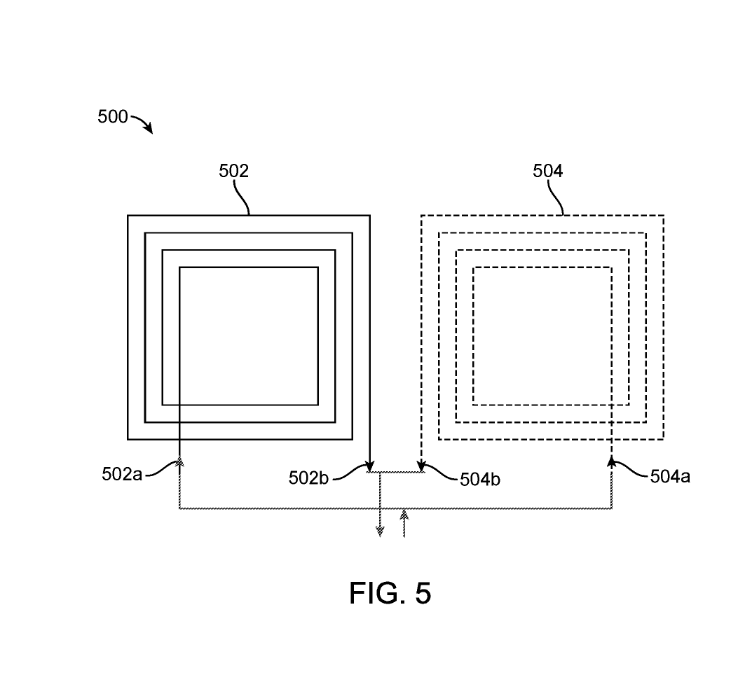

In some implementations, the positioning error (error in the position estimates) at offsets (distances) <20 cm may be specified to <2 cm, and for distances >20 cm to <1% of distance, e.g., <10 cm at a distance of 1 m and <50 cm at a distance of 5 m, where the distance refers to the horizontal distance between the magnetic centers of the magnetic field generator 368 and the magnetic field sensor 366 as defined in connection with FIGS. 4 and 5. The positioning error may refer to the error magnitude (error radius) and, e.g., to the 90th percentile of a position error statistics. Accordingly, the orientation error (error in the angle estimate) at distances <20 cm may be specified to <2°, and for distances >20 cm to <5°.

Further, electric vehicle controller 344 may be configured to communicate with electric vehicle onboard systems. For example, electric vehicle controller 344 may provide, via the electric vehicle communication interface, position data, e.g., for a brake system configured to perform a semi-automatic parking operation, or for a steering servo system configured to assist with a largely automated parking (“park by wire”) that may provide more convenience and/or higher parking accuracy as may be needed in certain applications to provide sufficient alignment between base and electric vehicle induction coils 304 and 316. Moreover, electric vehicle controller 344 may be configured to communicate with visual output devices (e.g., a dashboard display), acoustic/audio output devices (e.g., buzzer, speakers), mechanical input devices (e.g., keyboard, touch screen, and pointing devices such as joystick, trackball, etc.), and audio input devices (e.g., microphone with electronic voice recognition).

The wireless power transfer system 300 may also support plug-in charging via a wired connection, for example, by providing a wired charge port (not shown) at the electric vehicle wireless charging system 314. The electric vehicle wireless charging system 314 may integrate the outputs of the two different chargers prior to transferring power to or from the electric vehicle. Switching circuits may provide the functionality as needed to support both wireless charging and charging via a wired charge port.

To communicate between the base wireless charging system 302 and the electric vehicle wireless charging system 314, the wireless power transfer system 300 may use in-band signaling via base and electric vehicle induction coils 304, 316 and/or out-of-band signaling via communications systems (372, 374), e.g., via an RF data modem (e.g., Ethernet over radio in an unlicensed band). The out-of-band communication may provide sufficient bandwidth for the allocation of value-add services to the vehicle user/owner. A low depth amplitude or phase modulation of the wireless power carrier may serve as an in-band signaling system with minimal interference.

Some communications (e.g., in-band signaling) may be performed via the wireless power link without using specific communications antennas. For example, the base and electric vehicle induction coils 304 and 316 may also be configured to act as wireless communication antennas. Thus, some implementations of the base wireless charging system 302 may include a controller (not shown) for enabling keying type protocol on the wireless power path. By keying the transmit power level (amplitude shift keying) at predefined intervals with a predefined protocol, the receiver may detect a serial communication from the transmitter. The base power converter 336 may include a load sensing circuit (not shown) for detecting the presence or absence of active electric vehicle power receivers in the near-field coupling mode region of the base system induction coil 304. By way of example, a load sensing circuit monitors the current flowing to a power amplifier of the base power converter 336, which is affected by the presence or absence of active power receivers in the near-field coupling mode region of the base system induction coil 304. Detection of changes to the loading on the power amplifier may be monitored by the base controller 342 for use in determining whether to enable the base wireless charging system 302 for transmitting energy, to communicate with a receiver, or a combination thereof.

Referring to FIGS. 4A-4C, examples of winding bifilar wire on a coil holder are shown. An example induction coil 400 includes a coil holder 402 and an asymmetrically wound bifilar coil 404. The induction coil 400 also includes a plurality of ferrite layers 405a-d disposed over the bifilar coil 404. Additional ferrites may also be included on the opposite side of the induction coil 400. The bifilar coil 404 may be bifilar litz wire (i.e., with two parallel conductors). In an example, as depicted in FIG. 4A, the induction coil 400 is a combination of a double-D (DD) coil and a Solenoid coil designs (i.e., a DDS configuration). The DDS configuration is particularly useful as a vehicle pad induction coil because it is generally more tolerant to any misalignment with the base pad during charging operations. The DDS configuration, however, presents manufacturing challenges because they are difficult to wind. Specifically, the bifilar coil 404 in certain DDS configurations is wound in a series manner with a center crossover as depicted in FIGS. 4B and 4C. In an example, the two conductors in the bifilar coil 400 may be wound in a serial inside-to-outside-to-inside configuration 406. That is, the coil begins on the inside of a first loop with the windings extending to the outside of the first loop, and then serially transitioning over to the outside of a second loop and winding inwardly such that the windings end at the inside of the second loop. Alternatively, the two conductors in the bifilar coil 400 may be wound in a serial outside-to-inside-to-outside configuration 408. For example, the coil begins on the outside of a first loop and winds inwardly towards the center of the first loop, and then serially transitioning over to the inside of a second loop and winding outwardly to the outside of the second loop. Both examples present challenges for manufacturing. For example, winding the bifilar coil 400 can be time consuming because the litz wire is not fixed between ribs in every turn. Further, since hand winding is generally required, it is difficult to replicate the process accurately. Additionally, in the certain DDS configuration, the bifilar coils 400 are not symmetric which can create a difference in inductances and may degrade the operational performance of the coil.

Referring to FIG. 5, an example of a parallel coil winding structure 500 for a double-d (DD) configuration is shown. The parallel coil winding structure 500 includes a first coil 502 (with an inside lead 502a and an outside lead 502b ), and a second coil 504 (with an inside lead 504a and an outside lead 504b). The manufacturing issues associated with the DDS configuration described above may be overcome with the parallel coil winding structure 500 because each of the coils 502, 504 may be wound separately and connected to create parallel loops. For example, the outside lead 502a on the first coil 502 may be connected to the outside lead 504a on the second coil 504, and the inside lead 502b on the first coil 502 may be connected to the inside lead 504b on the second coil 504. Electrical current may be provided to the leads to promote horizontal flux across the DD structure. As compared with the bifilar coil 404, the parallel coil winding structure 500 is significantly easier to wind and may enable a more repeatable automated winding process.

In an embodiment, the first coil 502 and the second coil 504 may each be wound in the same direction (e.g., from inside to outside in a clockwise or counter-clockwise direction). When the coils 502, 504 are wound in the same direction, the desired horizontal flux may be achieved by wiring the coils in a series configuration. That is, the outside lead of the first coil may be connected to the inside lead of the second coil and the inside lead of the first coil may be connected to the outside lead of the second coil.

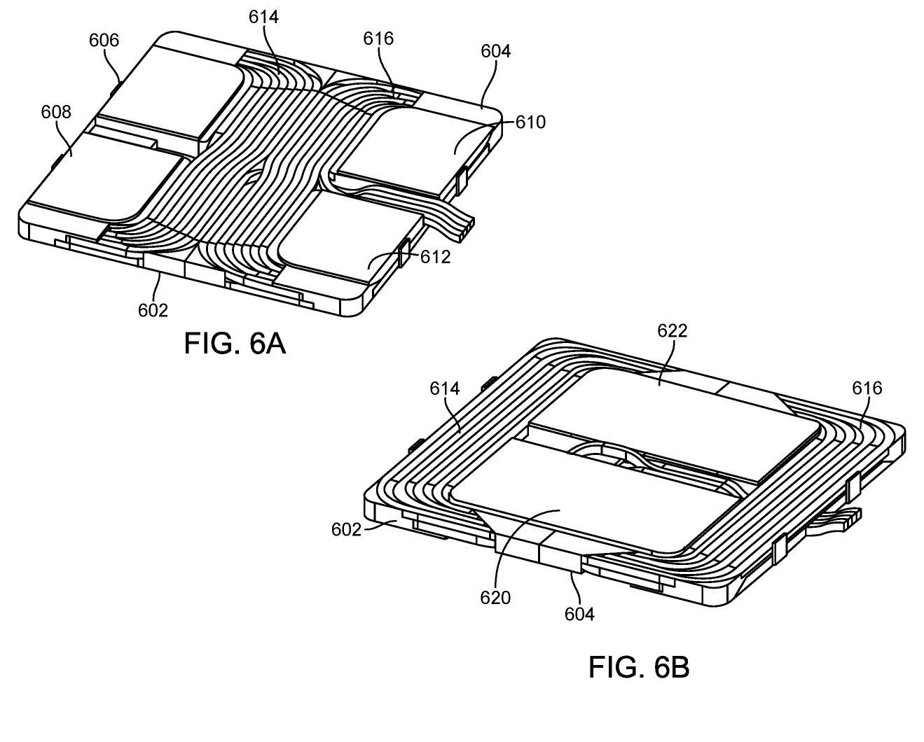

Referring to FIG. 6A, a top view perspective illustration of two adjacent combined ferrite and coil holders with parallel windings is shown. A first combined ferrite and coil holder 602 is disposed adjacent to a second combined ferrite and coil holder 604. The first combined ferrite and coil holder 602 and the second combined ferrite and coil holder 604 are generally rectangular and substantially planar in shape and include recesses (e.g., depressions) to accommodate ferrite block structures. The recesses may be a means for positioning the ferrite block structures. For example, the first combined ferrite and coil holder 602 is configured to accommodate a first ferrite block structure 606 and a second ferrite block structure 608 on a first side (e.g., the top side) of the first holder. The first combined ferrite and coil holder 602 is also configured to accommodate a first coil 614. The second combined ferrite and coil holder 604 is configured to accommodate a third ferrite block structure 610, a fourth ferrite block structure 612 (on top side of the second holder), and a second coil 616. In an embodiment, a first coil holder and a second coil holder may not include the recesses. A coil holder with or without the recesses may be a coil holder means. The first coil 614 and the second coil 616 may be uni-filar litz wire wound in an inside-to-outside configuration on their respective coil holders, and then operably coupled in a parallel configuration (e.g., as depicted in FIG. 5). As used herein, a uni-filar litz wire is a single wire which may include multiple strands. A uni-filar litz wire is differentiated from a bifilar litz wire because the uni-filar litz wire does not have a second closely spaced parallel winding. Since the first coil 614 and the second coil 616 are wound in opposite directions relative to one another, when the two coils are placed adjacent to one another and driven in parallel, they produce two magnetic pole areas and lines of magnetic flux between them. Referring to FIG. 6B, a bottom view perspective illustration of the first combined ferrite and coil holder 602 and the second combined ferrite and coil holder 604 is shown. When the combined ferrite and coil holders 602, 604 are placed adjacent to one another as depicted in FIG. 6B, they are configured to accommodate a fifth ferrite block structure 620 and a sixth ferrite block structure 622 on a second side (e.g., the bottom) of the combined ferrite and coil holders 602, 604. The fifth and sixth ferrite block structures 620, 622 are each disposed over a portion of the first coil 614 and the second coil 616. The ferrite block structures 606, 608, 610, 612, 620, 622 may be secured to the combined ferrite and coil holders 602, 604 using adhesive. In an example, the ferrite block structures 606, 608, 610, 612, 620, 622 are about 5 mm thick and 75 mm wide. The first, second, third and fourth ferrite blocks structures 606, 608, 610, 612 are about 75 mm in length, and the fifth and sixth ferrite block structures 620, 622 are about 150 mm in length. The dimensions of the ferrite block structures may vary based on the configuration of the first and second coil (e.g., dimension, number of windings, current). The sizes, locations and number of ferrite block structures are exemplary only and not a limitation as other sizes and locations may also be used. In an example the first ferrite block structure 606 and the second ferrite block structure 608 may be combined into a single ferrite block disposed on the first combined ferrite and coil holder 602. Similarly, the third ferrite block structure 610 and the fourth ferrite block structure 612 may be combined into a single ferrite block disposed on the second combined ferrite and coil holder 602. The fifth ferrite block structure 620 and the sixth ferrite block structure 622 may be combined into a single ferrite block structure disposed across at least a portion of the first coil 614 and the second coil 616.

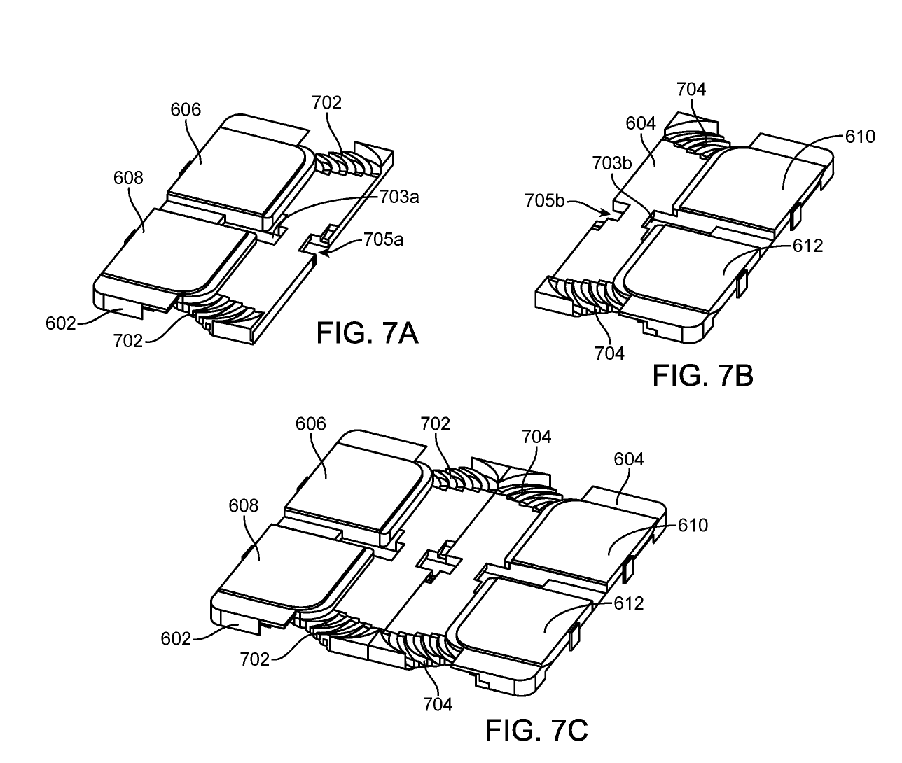

Referring to FIG. 7A, with further reference to FIG. 6A, a top view perspective illustration of a first combined ferrite and coil holder is shown. The first combined ferrite and coil holder 602 is shown in FIG.7A without the first coil 614. The first combined ferrite and coil holder 602 includes a plurality of ribs 702 configured to accommodate the uni-filar litz wire in the first coil 614. For example, the first coil 614 may be wound in an inside-to-outside configuration with the inside lead of the litz wire entering through an inside lead access port 703a, winding through the plurality of ribs 702 on each of multiple turns around the combined ferrite and coil holder 602, and then ending at a first coil outside lead access port 705a. Similarly, referring to FIG. 7B, the second combined ferrite and coil holder 604 includes a plurality of ribs 704 and is configured to accommodate the second coil 616. The second coil 616 may also be wound in an inside-to-outside configuration with the inside lead of the litz wire entering through an inside lead access port 703b, winding through the plurality of ribs 704 on each of multiple turns around the combined ferrite and coil holder 604, and then ending at a second coil outside lead access port 705b. As an example, and not a limitation, the first and second combined ferrite and coil holders 602, 604 may be constructed of a non-ferric material such as molded plastic and may be approximately 250 mm in length, 125 mm in width, and 5-10 mm in height. Other sizes may be used based on the charging application and other operational parameters.

Referring to FIG. 7C, with further reference to FIGS. 7A and 7B, a top view perspective illustration of the first and second combined ferrite and coil holders in an adjacent configuration is shown. The first combined ferrite and coil holder 602 and the second combined ferrite and coil holder 604 may be disposed adjacent to one another along a longitudinal access as depicted in FIG. 7C. The first coil outside lead access port 705a is aligned to the second coil outside lead access port 705b. In an example, the first and second combined ferrite and coil holders 602, 604 may be rigidly affixed to one another such as with adhesives or fasteners. In another example, the first and second combined ferrite and coil holders 602, 604 are not affixed to one another and either may be removed from the other for maintenance or replacement. For example, an external housing (not shown in FIG. 7C) may be configured to secure each of the coil holders such that they cannot move relative to one another. Other techniques, such as tongue and groove, alignment posts, clamps may be used to position the coil holders to one another.

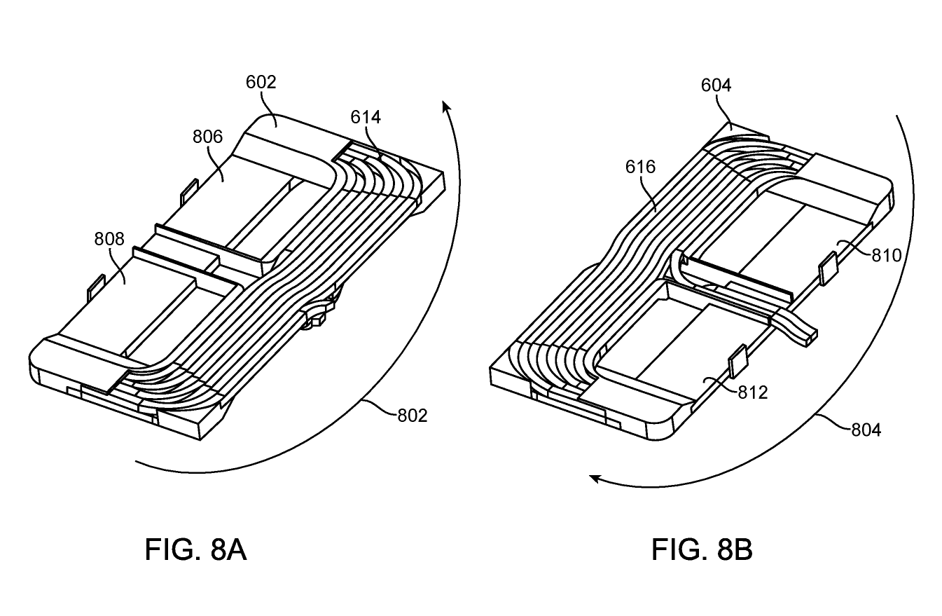

Referring to FIG. 8A, a top view perspective illustration of the first combined ferrite and coil holder 602 with a first coil 614 wound in a first direction 802 is shown. The first combined ferrite and coil holder 602 is depicted in FIG. 8A with the first and second ferrite block structures 606, 608 removed from the respective first and second ferrite block recesses 806, 808. The first coil 614 may be constructed of uni-filar litz wire (e.g., 1 mm, 2 mm, 4 mm, 8 mm) wound around the first combined ferrite and coil holder 602 in a first direction 802. For example, the first coil 614 may begin at the inside lead access port 703a (as shown in FIG. 7A), continue through the plurality of ribs 702 on each of multiple turns around the first combined ferrite and coil holder 602, and then ending at the first coil outside lead access port 705a (as shown in FIG. 7A). In an example, as depicted in FIG. 8A, the plane of the first coil 614 may be shifted to accommodate the first and second ferrite block recesses 806, 808. As defined herein, a substantially planar coil includes coils with a first side displaced approximately 5-10 mm from a second side of the coil.

Referring to FIG. 8B, a top view perspective illustration of the second combined ferrite and coil holder 604 with a second coil 616 wound in a second direction 804 is shown. The second combined ferrite and coil holder 604 is depicted in FIG. 8B with the third and fourth ferrite block structures 610, 612 removed from the respective third and fourth ferrite block recesses 810, 812. The second coil 616 may be constructed of same size uni-filar litz wire as used in the first coil 614 and may be wound around the second combined ferrite and coil holder 604 in a second direction 804 that is opposite from the first direction 802. The second coil 616 may begin at the inside lead access port 703b, continue through the plurality of ribs 704 on each of multiple turns around the second combined ferrite and coil holder 604, and then ending at the second coil outside lead access port 705b. In an example, as depicted in FIG. 8B, the plane of the second coil 616 may be shifted to accommodate the third and fourth ferrite block recesses 810, 812. The directions 802, 804 are exemplary only, and not a limitation. In an example, the first coil 614 and the second coil 616 may be wound in the same direction. In an example, the first combined ferrite and coil holder 602 and the second combined ferrite and coil holder 604 may be identical form factors (i.e., the same assembly/part).

In an embodiment, the coil holders 602, 604 may be symmetric from the top view and the bottom view. For example, the bottom view of the first holder 602 may be similar to the top view of the second holder 604. In this example, a single winding operation may be performed on both coil holders 602, 604 individually (i.e., winding in one direction). The first direction 802 and the second direction 804 may be realized by flipping one of the coil holders over. Symmetric top and bottom views are an example only and not a limitation.

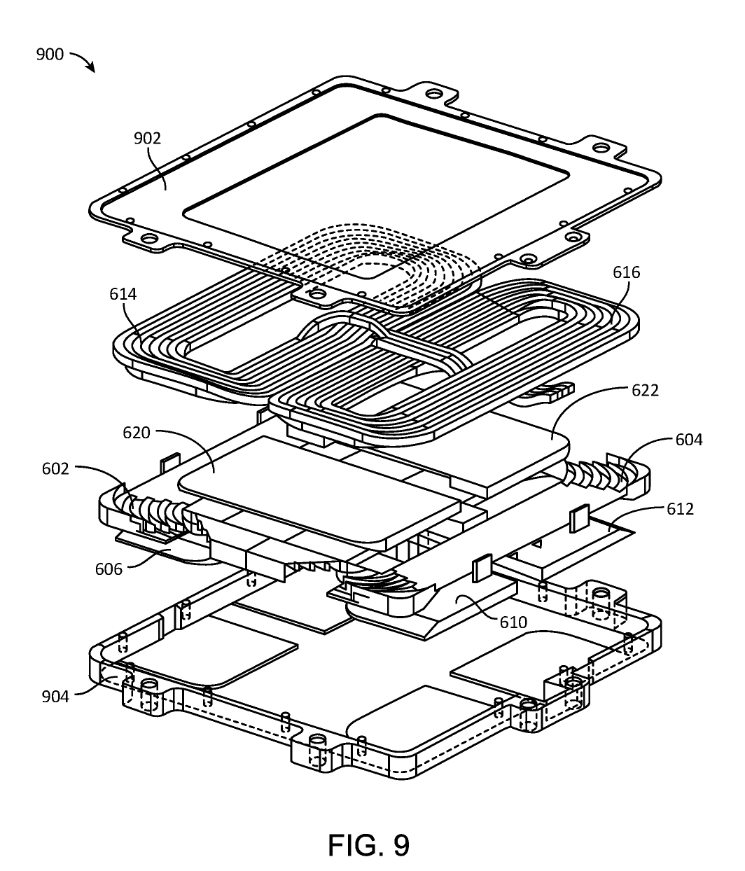

Referring to FIG. 9, with further reference to FIG. 1, an exploded diagram of an example induction coil 900 is shown. The induction coil 900 includes a first cover assembly 902 (e.g., a top), a second cover assembly 904 (e.g., a bottom), the first combined ferrite and coil holder 602, the second combined ferrite and coil holder 604, the first coil 614, the second coil 616, the first ferrite block structure 606, the second ferrite block structure (not visible in FIG. 9), the third ferrite block structure 610, the fourth ferrite block structure 612, the fifth ferrite block structure 620, and the sixth ferrite block structure 622. In operation, the first coil 614 and the second coil 616 are wrapped around the respective combined ferrite and coil holders 602, 604 as previously described. In an example, one or more of the ferrite block structures 606, 608, 610, 612, 620, 622 may be attached to the combined ferrite and coil holders 602, 604 with an adhesive (e.g., permanently affixed). In an example, one or more the ferrite block structures 606, 608, 610, 612, 620, 622 may be temporarily attached to the combined ferrite and coil holders 602, 604 via one or more fasteners or other technique. The top cover assembly 902 and the bottom cover assemble 904 may be an assembly cover means and may be constructed of a durable non-conducting non-magnetic material (e.g., plastic) and configured to encase the coil holders and ferrite blocks to provide protection from environmental elements. The cover assembles 902, 904 may include a sealing assembly (e.g., O-ring, gasket, caulk, etc.) configured to improve water resistance when the cover assemblies are fastened to one another. The top and bottom cover assemblies 902, 904 may be configured to support the first and second combined ferrite and coil holders 602, 604 such that combined ferrite and coil holders 602, 604 are adjacent when the induction coil 900 is assembled. In an example, the induction coil 900 is a vehicle induction coil 116 disposed on the underside of the vehicle 112 such that the first, second, third and fourth ferrite block structures 606, 608, 610, 612 are facing down towards the base system induction coil 104a. The induction coil 900 may be used as the base system coil 104a and the first, second, third and fourth ferrite block structures 606, 608, 610, 612 may be oriented in an upward direction towards a vehicle induction coil 116. The dimensions of the induction coil 900 may be varied for other wireless power transfer applications.

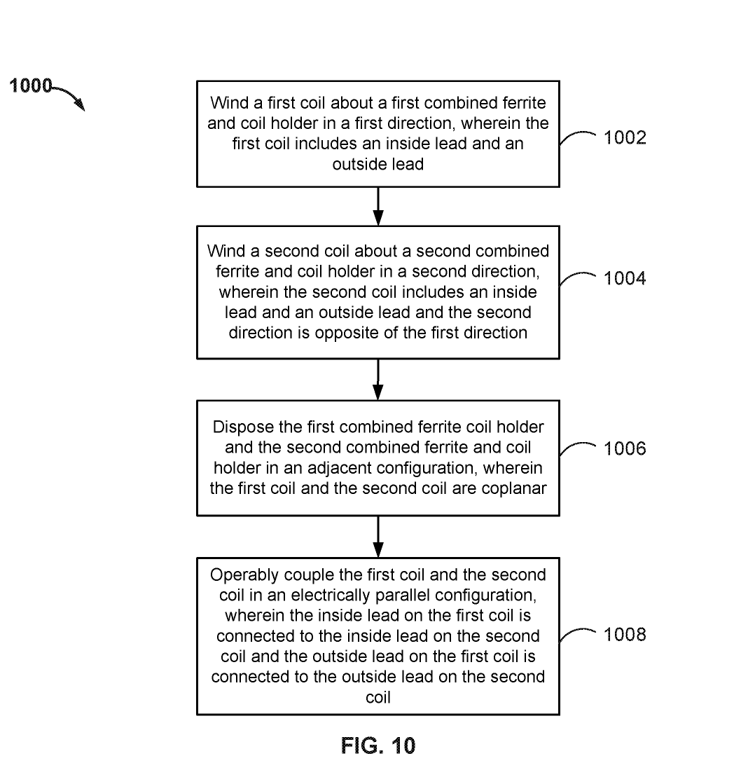

Referring to FIG. 10, with further reference to FIGS. 1-9, a method 1000 of assembling a double-D coil for the induction coil 900 includes the stages shown. The method 1000 is, however, an example only and not limiting. The method 1000 can be altered, e.g., by having stages added, removed, rearranged, combined, performed concurrently, and/or having single stages split into multiple stages.

At stage 1002, the method includes winding a first coil about a first combined ferrite and coil holder in a first direction, wherein the first coil includes an inside lead and an outside lead. Winding the first coil 614 about the first combined ferrite and coil holder 602 may be accomplished via hand winding or with the use of a winding machine. The first coil 614 may be a uni-filar litz wire or other conductor with an insulated coating. The first coil 614 may be wound in an inside-to-outside configuration with the inside lead of the coil at the inside lead access port 703a, then the coil is wound in a first direction 802 through the plurality of ribs 702 on each of multiple turns (e.g., 4-12 turns) around the first combined ferrite and coil holder 602, and then ending at a first coil outside lead access port 705a, which becomes the outside lead of the first coil.

At stage 1004, the method includes winding a second coil about a second combined ferrite and coil holder in a second direction, wherein the second coil includes an inside lead and an outside lead and the second direction is opposite of the first direction. Winding the second coil 616 about the second combined ferrite and coil holder 604 may also be accomplished via hand winding or with the use of a winding machine. The second coil 616 may be a uni-filar litz wire or other conductor with an insulated coating. The second coil 616 may be wound in an inside-to-outside configuration with the inside lead of the coil at the inside lead access port 703b, then the coil is wound in a second direction 804 through the plurality of ribs 704 on each of multiple turns (e.g., the same number of turns as the first coil 614) around the second combined ferrite and coil holder 604, and then ending at a second coil outside lead access port 705b, which becomes the outside lead of the second coil. In an example, first combined ferrite and coil holder 602 and the second combined ferrite and coil holder 604 may have the same form factor (e.g., the same part) with the difference being the directions in which the first and second coils 614, 616 are wound (e.g., the first direction 802 and the second direction 804).

At stage 1006, the method includes disposing the first combined ferrite and coil holder and second combined ferrite and coil holder in an adjacent configuration, wherein the first coil and the second coil are coplanar. The first combined ferrite and coil holder 602 and the second combined ferrite and coil holder 604 are placed adjacent to one another such that the first and second coil outside lead access ports 705a-b are next to one another, such as depicted in FIG. 7C. The first combined ferrite and coil holder 602 and the second combined ferrite and coil holder 604 may be fastened to one another with an adhesive, one or more fasteners, or other clamping techniques. In an example, the first combined ferrite and coil holder 602 and the second combined ferrite and coil holder 604 may be configured to be subsequently separated from one another (e.g., removable fasteners, no adhesive) to facilitate servicing and/or replacing the coils. In an embodiment, the first combined ferrite and coil holder 602 and the second combined ferrite and coil holder 604 may include one or more alignment structures (e.g., tongue and groove, alignment posts/holes, shiplap edges, etc.) configured to maintain the alignment between the combined ferrite and coil holders 602, 604. As depicted in FIG. 6A, the first coil 614 and the second coil 616 are coplanar with one another when the first combined ferrite and coil holder 602 and the second combined ferrite and coil holder 604 are placed adjacent to each other. As used herein, the term coplanar includes the displacement to the first and second coils 614, 616 created by the ferrite block recesses 806, 808, 810, 812.

At stage 1008, the method includes operably coupling the first coil and the second coil in an electrically parallel configuration, wherein the inside lead on the first coil is connected to the inside lead on the second coil and the outside lead on the first coil is connected to the outside lead on the second coil. A coupling means may include a physical connector or other electrical coupling techniques such as a soldered connection. In an example, the inside lead and the outside lead of the first coil 614 may be routed from the inside lead access port 703a and the outside lead access port 705a, respectively, to the inside lead access port 703b such as depicted in FIGS. 6A and 6B. The leads on the first and second coils 614, 616 may be routed to external terminals such that the coils 614, 616 are in an electrically parallel configuration. For example, the inside lead on the first coil 614 is connected to the inside lead on the second coil 616 and the outside lead on the first coil 614 is connected to the outside lead on the second coil 616, such as depicted in FIG. 5. The terminals may be included in a resonant circuit such as a base resonant circuit 206 or a vehicle resonant circuit 222, such that the adjacent first and second combined ferrite and coil holders 602, 604, with the parallel first and second coils 614, 616, are the respective base system induction coil 204 or the vehicle induction coil 216.

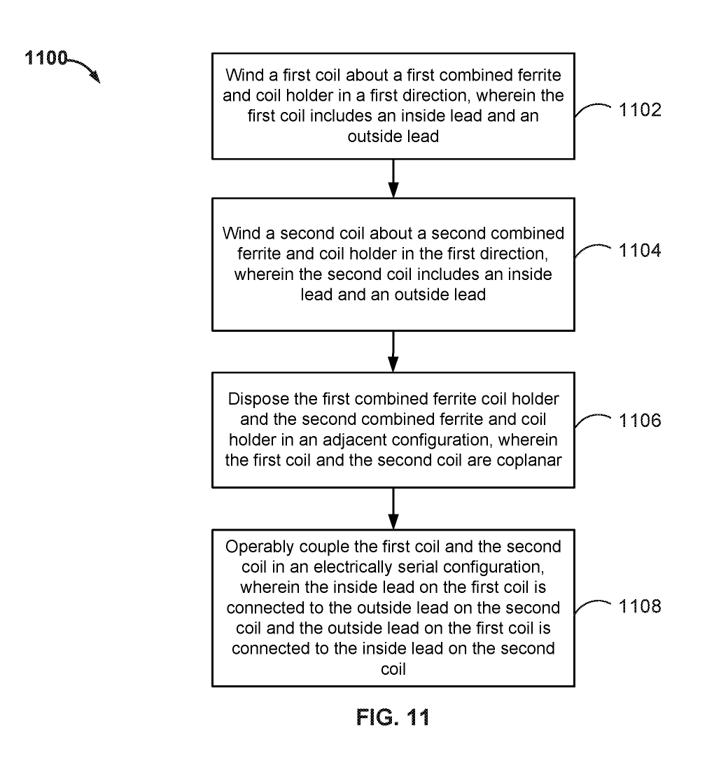

In an embodiment, the coils 614, 616 may be wound in the same direction and then operably coupled in a series configuration. For example, referring to FIG. 11, with further reference to FIGS. 1-9, another method 1100 of assembling a double-D coil for the induction coil 900 includes the stages shown. The method 1100 is, however, an example only and not limiting. The method 1100 can be altered, e.g., by having stages added, removed, rearranged, combined, performed concurrently, and/or having single stages split into multiple stages.

At stage 1102, the method includes winding a first coil about a first combined ferrite and coil holder in a first direction, wherein the first coil includes an inside lead and an outside lead. Winding the first coil 614 about the first combined ferrite and coil holder 602 may be accomplished as previously described at stage 1002 in FIG. 10.

At stage 1104, the method includes winding a second coil about a second combined ferrite and coil holder in the first direction, wherein the second coil includes an inside lead and an outside lead. Winding the second coil 616 about the second combined ferrite and coil holder 604 in the same direction as the first combined ferrite and coil holder may allow for more repeatable winding processes. For example, a single winding machine may be used for both coil holders. The second coil 616 may be a uni-filar litz wire or other conductors as previously described. The second coil 616 may be wound in an inside-to-outside configuration with the inside lead of the coil at the inside lead access port 703b, then the coil is wound in a second direction 804 through the plurality of ribs 704 on each of multiple turns (e.g., the same number of turns as the first coil 614) around the second combined ferrite and coil holder 604, and then ending at a second coil outside lead access port 705b, which becomes the outside lead of the second coil.

At stage 1106, the method includes disposing the first combined ferrite and coil holder and second combined ferrite and coil holder in an adjacent configuration, wherein the first coil and the second coil are coplanar. The first combined ferrite and coil holder 602 and the second combined ferrite and coil holder 604 are placed adjacent to one another such that the first and second coil outside lead access ports 705a-b are next to one another, such as depicted in FIG. 7C. The first combined ferrite and coil holder 602 and the second combined ferrite and coil holder 604 may be fastened to one another as described at stage 1006 in FIG. 10.

At stage 1108, the method includes operably coupling the first coil and the second coil in an electrically serial configuration, wherein the inside lead on the first coil is connected to the outside lead on the second coil and the outside lead on the first coil is connected to the inside lead on the second coil. In an example, the inside lead and the outside lead of the first and second coils be routed from their respective inside and outside lead access ports and wired such that the first and second coils are in an electrically serial configuration. For example, the inside lead on the first coil is connected to the outside lead on the second coil, and the outside lead on the first coil is connected to the inside lead on the second coil. The single direction winding and the serial winding configuration may reduce the manufacturing complexity of a vehicle induction coil assembly.

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform one or more of the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

1. A wireless power transfer device, comprising:
a first combined ferrite and coil holder and a second combined ferrite and coil holder, wherein the first combined ferrite and coil holder and the second combined ferrite and coil holder are separate components;
a first coil disposed on the first combined ferrite and coil holder; and
a second coil disposed on the second combined ferrite and coil holder, wherein the second combined ferrite and coil holder is adjacent to and coplanar with the first combined ferrite and coil holder, and the first coil and the second coil are operably coupled to one another.

2. The wireless power transfer device of claim 1 further comprising:
a first ferrite block structure disposed on a first side of the first combined ferrite and coil holder;
a second ferrite block structure disposed on the first side of the first combined ferrite and coil holder;
a third ferrite block structure disposed on a first side of the second combined ferrite and coil holder;
a fourth ferrite block structure disposed on the first side of the second combined ferrite and coil holder;
a fifth ferrite block structure disposed across at least a portion of a second side opposite the first side of the first combined ferrite and coil holder and a second side of the second combined ferrite and coil holder; and
a sixth ferrite block structure disposed across at least a portion of the second side of the first combined ferrite and coil holder and the second side of the second combined ferrite and coil holder.

3. The wireless power transfer device of claim 2 wherein the first side of the first combined ferrite and coil holder includes a plurality of recesses configured to accommodate the first ferrite block structure and the second ferrite block structure.

4. The wireless power transfer device of claim 2 wherein the second side of the first combined ferrite and coil holder includes a plurality of recesses configured to accommodate at least a portion of the fifth ferrite block structure and at least a portion of the sixth ferrite block structure.

5. The wireless power transfer device of claim 2 wherein the first combined ferrite and coil holder and the second combined ferrite and coil holder are disposed within a first cover assembly and a second cover assembly.

6. The wireless power transfer device of claim 1 wherein the first coil and the second coil are comprised of uni-filar litz wire.

7. The wireless power transfer device of claim 1 wherein the first combined ferrite and coil holder and the second combined ferrite and coil holder have the same form factor.

8. The wireless power transfer device of claim 1 wherein the first combined ferrite and coil holder includes a plurality of ribs configured to align the first coil.

9. The wireless power transfer device of claim 1 wherein the first combined ferrite and coil holder includes one or more alignment structures.

10. The wireless power transfer device of claim 1 wherein the first coil and the second coil are operably connected to generate a horizontal flux across the wireless power transfer device.

11. The wireless power transfer device of claim 1 wherein the first coil is wound around the first combined ferrite and coil holder in a first direction, the second coil is wound around the second combined ferrite and coil holder in a second direction, and the first coil and the second coil are operably coupled in an electrically parallel configuration.

12. The wireless power transfer device of claim 1 wherein the first coil is wound around the first combined ferrite and coil holder in a first direction, the second coil is wound around the second combined ferrite and coil holder in the first direction, and the first coil and the second coil are operably coupled in an electrically serial configuration.

13. The wireless power transfer device of claim 1 wherein the first combined ferrite and coil holder includes a first coil outside lead access port, the second combined ferrite and coil holder includes a second coil outside lead access port, wherein the first coil outside lead access port and the second coil outside lead access port are adjacent when the second combined ferrite and coil holder is adjacent to and coplanar with the first combined ferrite and coil holder.

14. A method of assembling an induction coil, comprising:
winding a first coil about a first combined ferrite and coil holder in a first direction, wherein the first coil includes an inside lead and an outside lead;
winding a second coil about a second combined ferrite and coil holder in a second direction, wherein the second coil includes an inside lead and an outside lead and the second direction is opposite of the first direction;
disposing the first combined ferrite and coil holder and the second combined ferrite and coil holder in an adjacent configuration, wherein the first coil and the second coil are coplanar; and
operably coupling the first coil and the second coil in a parallel configuration, wherein the inside lead on the first coil is connected to the inside lead on the second coil and the outside lead on the first coil is connected to the outside lead on the second coil.

15. The method of claim 14 wherein the first combined ferrite and coil holder and the second combined ferrite and coil holder have the same form factor.

16. The method of claim 14 further comprising:
positioning a first ferrite block structure on a first side of the first combined ferrite and coil holder;
positioning a second ferrite block structure to the first side of the first combined ferrite and coil holder;
positioning a third ferrite block structure to a first side of the second combined ferrite and coil holder;
positioning a fourth ferrite block structure to the first side of the second combined ferrite and coil holder;
positioning a fifth ferrite block structure to a second side opposite the first side of the first combined ferrite and coil holder and a second side opposite the first side of the second combined ferrite and coil holder; and
positioning a sixth ferrite block structure to the second side of the first combined ferrite and coil holder and the bottom of the second combined ferrite and coil holder.

17. The method of claim 14 further comprising encasing the first combined ferrite and coil and the second combined ferrite and coil within a top cover assembly and a bottom cover assembly.

18. The method of claim 14 further comprising coupling the inside lead and the outside lead of the first coil and the second coil to a power converter.

19. The method of claim 18 wherein the induction coil is disposed on a vehicle such that the first side of the first combined ferrite and coil holder and the second combined ferrite and coil holder are directed to a base system induction coil.

20. An apparatus, comprising:
a first holder means for securing a first coil, wherein the first coil includes an inside lead and an outside lead;
a second holder means for securing a second coil, wherein the second coil includes an inside lead and an outside lead;
an assembly cover means for disposing the first holder means and the second holder means in an adjacent configuration, wherein the first coil and the second coil are coplanar; and
a coupling means for electrically coupling the first coil and the second coil.

21. The apparatus of claim 20 wherein the coupling means includes electrically coupling the first coil and the second coil in a parallel configuration, wherein the inside lead on the first coil is connected to the inside lead on the second coil and the outside lead on the first coil is connected to the outside lead on the second coil.

22. The apparatus of claim 20 wherein the coupling means includes electrically coupling the first coil and the second coil in a serial configuration, wherein the inside lead on the first coil is connected to the outside lead on the second coil and the outside lead on the first coil is connected to the inside lead on the second coil.

23. The apparatus of claim 20 wherein the first holder means and the second holder means have the same form factor.

24. The apparatus of claim 20 further comprising:
means for positioning a first ferrite block structure on a first side of the first holder means;
means for positioning a second ferrite block structure to the first side of the first holder means;
means for positioning a third ferrite block structure to a first side of the second holder means;
means for positioning a fourth ferrite block structure to the first side of the second holder means;
means for positioning a fifth ferrite block structure to a second side opposite the first side of the first holder means and a second side opposite the first side of the second holder means; and
means for positioning a sixth ferrite block structure to the second side of the first holder means and the second side of the second holder means.

25. The apparatus of claim 20 further comprising means for coupling the first coil and the second coil to a power converter means.

26. The apparatus of claim 25 wherein the apparatus is disposed on a vehicle such that a first side of the first holder means and the second holder means are directed to a base system induction coil.

27. A wireless power transfer device, comprising:
a first coil holder and a second coil holder, wherein the first coil holder and the second coil holder have the same form factor;
a first coil disposed on the first coil holder;
a second coil disposed on the second coil holder, wherein the second coil holder is adjacent to and coplanar with the first coil holder, and the first coil and the second coil are operably coupled to one another;
a first ferrite block structure disposed on a first side of the first coil holder;
a second ferrite block structure disposed on the first side of the first coil holder;
a third ferrite block structure disposed on a first side of the second coil holder;
a fourth ferrite block structure disposed on the first side of the second coil holder;
a fifth ferrite block structure disposed across at least a portion of a second side opposite the first side of the first coil holder and a second side of the second coil holder; and
a sixth ferrite block structure disposed across at least a portion of the second side of the first coil holder and the second side of the second coil holder.

28. The wireless power transfer device of claim 27 wherein the first side of the first coil holder includes a plurality of recesses configured to accommodate the first ferrite block structure and the second ferrite block structure.

29. The wireless power transfer device of claim 27 wherein the first coil is wound around the first coil holder in a first direction, the second coil is wound around the second coil holder in a second direction, and the first coil and the second coil are operably coupled in an electrically parallel configuration.

30. The wireless power transfer device of claim 27 wherein the first coil is wound around the first coil holder in a first direction, the second coil is wound around the second coil holder in the first direction, and the first coil and the second coil are operably coupled in an electrically serial configuration.
